(19) United States
(12) Patent Application Publication
(10) Pub. No.: US 2026/0097712 A1
(43) Pub. Date: Apr. 9, 2026

(54) VEHICLE REAR CARGO STRUCTURE

(71) Applicant: NISSAN NORTH AMERICA, INC., Franklin, TN (US)

(72) Inventor: Matthew MCCORMICK, Farmington Hills, MI (US)

(21) Appl. No.: 18/908,770

(22) Filed: Oct. 7, 2024

(51) Int. Cl. B60R 5/04; B60R 5/00

(52) U.S. Cl. CPC B60R 5/044; B60R 5/003

(57) ABSTRACT

A vehicle rear cargo structure includes a side wall. A shelf is coupled to the side wall. A shelf has an upper surface and a vertical surface that extends downward from the upper horizontal surface. The slot has a first section and a second section. The first section is open to the upper surface of the shelf and the second section of the slot is open to and extends along the vertical surface. The lugboard has a pin extending from beneath a portion of the lugboard. The pin is dimensioned to pass into the first section of the slot during positioning of the lugboard on the shelf. The pin is dimensioned such that with the portion of the lugboard overlaying the upper surface of the shelf, movement of the lugboard correspondingly moves the pin along the second section of the slot away from the first section of the slot.

### BACKGROUND

### Technical Field

The present disclosure generally relates to vehicle rear cargo structure. More specifically, the present disclosure relates to a vehicle rear cargo structure that includes shelves with slots that simplify the assembly process of the rear cargo structure.

### Background Information

Vehicles such as sports utility vehicles (SUVs) typically have a rear cargo area.

### SUMMARY

One object of the present disclosure is to provide a rear cargo structure of a vehicle with an operator accessible lug box but restrict access to a covered compartment with easy to assembly elements.

In view of the state of the known technology, one aspect of the present disclosure is to provide a vehicle rear cargo structure includes a side wall, a shelf and a lugboard. The shelf is coupled to the side wall. The shelf has an upper surface and a vertical surface that extends downward from the upper horizontal surface. The slot has a first section and a second section. The first section is open to the upper surface of the shelf and the second section of the slot is open to and extends along the vertical surface. The lugboard has a pin extending from beneath a portion of the lugboard. The pin is oriented and dimensioned to pass into the first section of the slot during positioning of the lugboard on the shelf. The pin is oriented and dimensioned such that with the portion of the lugboard overlaying the upper surface of the shelf, movement of the lugboard correspondingly moves the pin along the second section of the slot away from the first section of the slot.

### BRIEF DESCRIPTION OF THE DRAWINGS

Referring now to the attached drawings which form a part of this original disclosure:

FIG. 1 is a perspective rear view of a vehicle that includes a rear cargo structure in accordance with an exemplary embodiment;

FIG. 2 is another rear view of the vehicle with outer body panels, various element of the vehicle and the rear door removed to expose features of the rear cargo structure and showing a lug box lid in a closed orientation in accordance with the exemplary embodiment;

FIG. 3 is a rear view of the vehicle with a roof structure, outer body panels, and the rear door removed to expose features of the rear cargo structure and showing a lug box lid of the rear cargo structure in an open orientation in accordance with the exemplary embodiment;

FIG. 4 is a perspective side cut-away view with one side wall of the body structure removed showing a lug box, a lug box lid, a concealed compartment and a lugboard that covers and conceals the concealed compartment in accordance with the exemplary embodiment;

FIG. 5 is a side perspective view of a side wall of the rear cargo structure with an interior trim panel removed showing a wheel well and first, second and third brackets welded to the wheel well in accordance with the exemplary embodiment;

FIG. 6 is another side perspective view of the side wall of the rear cargo structure from an angle that differs from FIG. 5 with an interior trim panel removed showing the wheel well with the first, second and third brackets welded to the wheel well in accordance with the exemplary embodiment;

FIG. 7 is a side view of the side wall showing a shelf with a forward end thereof being attached to the first bracket in accordance with the exemplary embodiment;

FIG. 8 is a second side view of the side wall showing the shelf with a rearward end thereof being attached to the second bracket in accordance with the exemplary embodiment;

FIG. 9 is a perspective view showing the forward end of the shelf fixed to the first bracket via a mechanical fastener in accordance with the exemplary embodiment;

FIG. 10 is a side view of the wheel well of the rear cargo structure showing the shelf attached to the first bracket and the lugboard just prior to installation of the lugboard to the shelf in accordance with the exemplary embodiment;

FIG. 11 is another side view of the wheel well of the rear cargo structure showing the shelf attached to the first bracket and the lugboard in an intermediate orientation part way through installation of the lugboard to the shelf in accordance with the exemplary embodiment;

FIG. 12 is a rear perspective view of the wheel well showing the second bracket welded to the wheel well and the shelf attached via mechanical fastener to the second bracket in accordance with the exemplary embodiment;

FIG. 13 is a perspective view of the wheel well showing the first, second and third brackets with the shelf attached to the first and second brackets in accordance with the exemplary embodiment;

FIG. 14 is a perspective view of the rear end of the shelf looking upward as the shelf is aligned with second bracket during installation of the shelf to the second bracket in accordance with the exemplary embodiment;

FIG. 15 is a perspective view of the rear end of the shelf looking downward as the shelf is aligned with second bracket during installation of the shelf to the second bracket in accordance with the exemplary embodiment;

FIG. 16 is a front view of the shelf in accordance with the exemplary embodiment;

FIG. 17 is a side view of the shelf showing the inboard features of the shelf in accordance with the exemplary embodiment;

FIG. 18 is a rear view of the shelf in accordance with the exemplary embodiment;

FIG. 19 is a front perspective view of the shelf in accordance with the exemplary embodiment;

FIG. 20 is a top view of the shelf in accordance with the exemplary embodiment;

FIG. 21 is a rear perspective view of the shelf in accordance with the exemplary embodiment;

FIG. 22 is a perspective view of the side wall of the rear cargo area showing the shelf installed to the first and second brackets with the interior trim panel concealing the first and second brackets and concealing an outboard portion of the shelf in accordance with the exemplary embodiment;

FIG. 23 is a perspective view of the side wall of the rear cargo area similar to FIG. 22 but with the interior trim panel removed in accordance with the exemplary embodiment;

FIG. 24 is a perspective view of the side wall of the rear cargo area showing the lugboard installed to the shelf with the interior trim panel concealing the first and second brackets and concealing an outboard portion of the shelf in accordance with the exemplary embodiment;

FIG. 25 is a front perspective view of the lugboard removed from the rear cargo structure in accordance with the exemplary embodiment;

FIG. 26 is a bottom view of the lugboard removed from the rear cargo structure in accordance with the exemplary embodiment;

FIG. 27 is a bottom perspective view of the lugboard removed from the rear cargo structure in accordance with the exemplary embodiment;

FIG. 28 is a front view of the lugboard removed from the rear cargo structure in accordance with the exemplary embodiment;

FIG. 29 is a side view of the lugboard removed from the rear cargo structure in accordance with the exemplary embodiment;

FIG. 30 is a perspective view of the side wall showing the interior trim panel concealing the outboard portions of the shelf and showing a cargo hook that is attached to the third bracket concealed behind the interior trim panel in accordance with the exemplary embodiment;

FIG. 31 is a side schematic view of the shelf showing a pin that extends from an outboard side of the lugboard into a slot of the shelf and further showing movement of the pin in phantom as the pin and the lugboard are moved into an installed position relative to the shelf and the slot in accordance with the exemplary embodiment;

FIG. 32 is another perspective view of the rear cargo area showing the lugboard installed to the shelf with the lug box removed showing the floor of the rear cargo area in accordance with the exemplary embodiment;

FIG. 33 is another perspective view of the rear cargo area similar to FIG. 32 showing the lugboard installed to the shelf with the lug box lid covering the lug box in accordance with the exemplary embodiment;

FIG. 34 is another perspective view of the rear cargo area similar to FIGS. 32 and 33 showing the lug box lid covering the lug box with the lugboard removed showing the concealed compartment in accordance with the exemplary embodiment;

FIG. 35 is a bottom perspective view (looking upward) of the shelf and lugboard showing the pin of the lugboard within the slot of the shelf in accordance with the exemplary embodiment;

FIG. 36 is another bottom perspective view (looking upward) of the shelf and lugboard showing the pin of the lugboard within the slot of the shelf in accordance with the exemplary embodiment;

FIG. 37 is another perspective view of the cargo area showing the lugboard and a hinged gap cover 114 of the lugboard with the lug box lid and the lug box removed in accordance with the exemplary embodiment;

FIG. 38 is a front perspective view of the rear cargo area showing the lug box lid and the lugboard in place on the shelf and further showing a forward upright panel prior to installation to the lugboard and brackets on the floor of the rear cargo area in accordance with the exemplary embodiment;

FIG. 39 is another front perspective view of the rear cargo area showing the lug box lid and the lugboard in place on the shelf and further showing the forward upright panel installed and attached to the lugboard and brackets on the floor of the rear cargo area in accordance with the exemplary embodiment;

FIG. 40 is a bottom perspective view (looking upward) at the bracket on a lower surface of the lugboard with the forward upright panel attached to the bracket of the lugboard

FIG. 41 is a perspective view of the rear cargo structure showing the floor backets that the forward upright panel attaches to and the brackets of the lugboard that the forward upright panel attaches to in accordance with the exemplary embodiment;

FIG. 42 is a bottom perspective view of the rear cargo structure showing a mechanical fastener attaching a bracket of the lugboard to a rearward end of the shelf in accordance with the exemplary embodiment;

FIG. 43 is a cross-sectional view of the hinged gap cover attached via mechanical fasteners to the lug box lid in accordance with the exemplary embodiment;

FIG. 44 is a perspective view of the rear cargo structure with the lug box lid in a closed orientation (solid line) and an open orientation (phantom line) supported by the hinged gap cover in accordance with the exemplary embodiment;

FIG. 45 is a cross-sectional view of the hinged gap cover showing the lug box lid in the closed orientation in accordance with the exemplary embodiment;

FIG. 46 is a cross-sectional view of the hinged gap cover showing the lug box lid in a partially open orientation in accordance with the exemplary embodiment; and

FIG. 47 is a cross-sectional view of the hinged gap cover showing the lug box lid in a fully open orientation in accordance with the exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

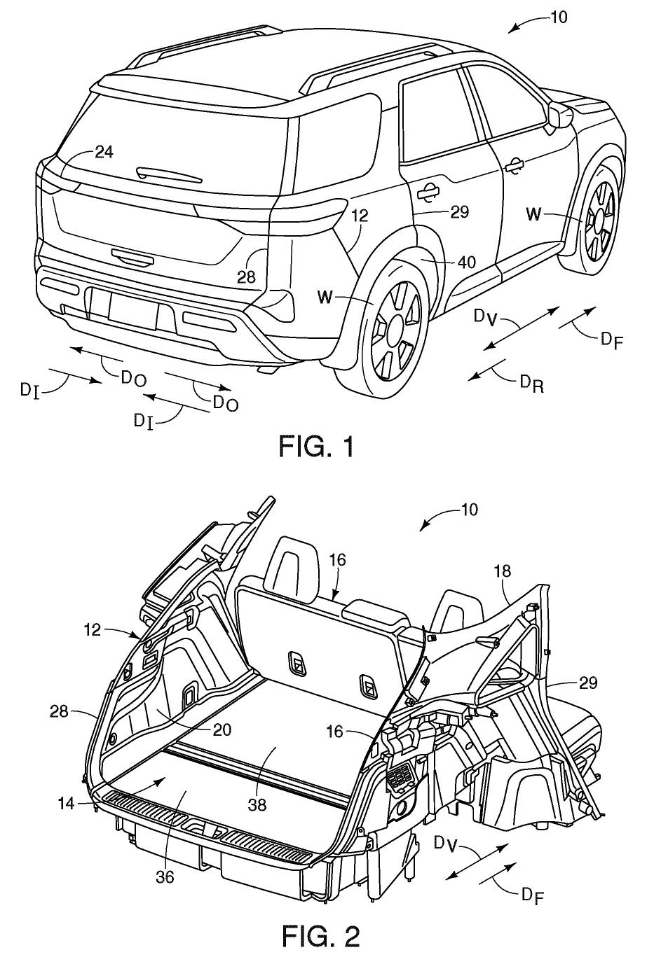

Referring initially to FIGS. 1-4, a vehicle 10 having a vehicle rear cargo structure 12 is illustrated in accordance with an exemplary embodiment. The vehicle 10 defines a vehicle longitudinal direction D_{V}, a vehicle forward direction D_{F}, a vehicle rearward direction D_{R}, vehicle inboard directions D_{I} and vehicle outboard directions D_{O}.

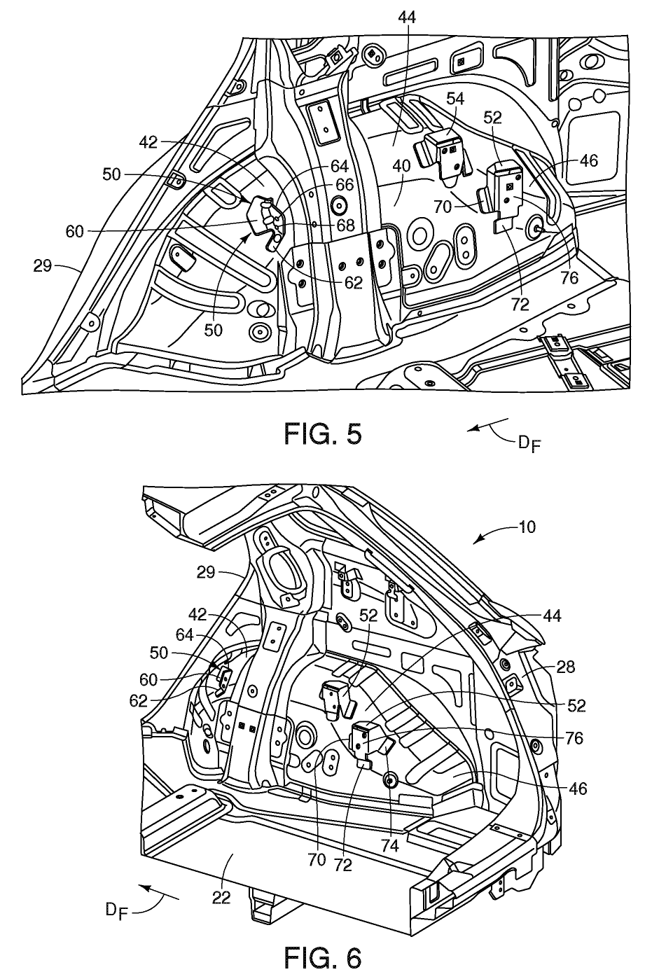

As shown in FIGS. 2-4, the vehicle rear cargo structure 12 includes cargo area 14 located behind second row seats 16 within a passenger compartment 18 of the vehicle 10. The cargo area 14 is bordered by interior trim panels 20, the second row seats 16, a floor 22 (shown in FIG. 4), a rear door 24 (shown in FIG. 1) and side walls 26 (FIGS. 5-12). In FIGS. 2-4, the side walls 26 are at least partially covered and/or concealed by the interior trim panels 20. The vehicle 10 and vehicle rear cargo structure 12 also define a rear hatch opening 28 and a rear side door opening 29.

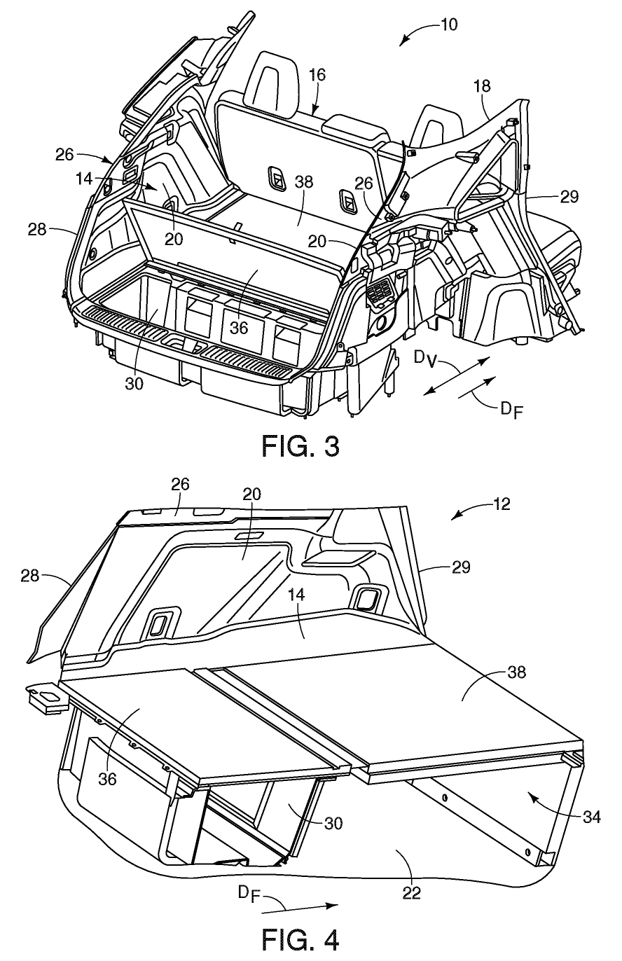

The cargo area 14 includes a lug box 30 and a concealed compartment 34. The lug box 30 has a lug box lid 36 that pivots between a closed orientation shown in FIG. 2 and an open orientation shown in FIG. 3. In the closed orientation, the lug box lid 36 covers and conceals any contents of the lug box 30. In the open orientation, the lug box lid 36 allows full access by a vehicle operator to the contents of the lug box 30. The concealed compartment 34 is covered by a lugboard 38 that is attached to structures (described further below) that prevents or at least limits access to the contents of the concealed compartment 34. The concealed compartment 34 can house, for example, electronic devices (not shown), a battery or batteries (not shown), and/or other devices (not shown), or mechanisms (not shown), that are meant to be accessed by a technician, not the vehicle operator.

A description of the lugboard 38 and related structures is provided in greater detail below following a description of structures including brackets on the side walls 26 that are at least partially or completely hidden and/or concealed by the interior trim panels 20 in FIGS. 2-4.

FIGS. 5-12 show the cargo area 14 with the interior trim panels 20 removed revealing details of the side walls 26. There are two side walls 26, one on each lateral side of the cargo area 14. The interior portions of the side walls 26 are basically identical except that they are mirror images of one another. Therefore, only one side wall 26 is described herein below for the sake of brevity but applies equally to both side walls 26.

The side wall 26 includes a panel or panels welded together to define an inner wheel well 40. The inner wheel well 40 is shaped to define a partial wheel shape that is spaced apart from the adjacent one of the wheels W and defines a barrier between the cargo area 14 and the wheel W. More specifically, the wheel well W includes a forward area 42, a mid-area 44 and a rearward area 46 all having contoured surfaces with little or no flat surface portions. The contoured surfaces of the forward, the mid and the rearward areas 42, 44 and 46 are curved to correspond to mimic the shape of the adjacent wheel W shielding the cargo area 14 from the wheel W. In FIGS. 2-4, the wheel well 40 is concealed by the interior trim panel 20 and is exposed in FIGS. 5-9.

The wheel well 40 has a first bracket 50, a second bracket 52 and a third bracket 54 attached thereto. More specifically, the first bracket 50 is attached to the forward area 42, the second bracket 52 is attached to the mid area 44 and the third bracket 54 is also attached to the mid area 44 adjacent to and above the second bracket 52.

The first bracket 50 includes a first offset flanges 60 and 62, and an upright flange 64. The offset flanges 60 and 62 are shaped and oriented to attach to the contoured surface of the forward area 42 of the wheel well 40. Each of the offset flanges 60 and 62 is welded to the contoured surface of the forward area 42 of the wheel well 40. The upright flange 64 is generally vertical and extends in an inboard direction from the offset flanges 60 and 62. The upright flange 64 includes a first fastener attachment structure 66 and a slot 68 below the first fastener attachment structure 66. The first fastener attachment structure 66 can be, for example, an opening, a threaded opening or an opening with a threaded nut welded thereto. The offset flange 60 and the offset flange 62 are not co-planar because the contoured surface (curved surface) of the forward area 42 is not flat nor does it define a planar surface. The upright flange 64 extends in the vehicle inboard direction D_{I} from the offset flange 60 and the offset flange 62.

The second bracket 52 is fixedly attached to the mid-area 44 of the wheel well 40. The second bracket 52 includes offset flanges 70, 72 and 74 and an upright flange 76. The offset flanges 70, 72 and 74 are not co-planar but rather are offset from one another in order to lay against the contoured (curved) surface of the mid area 44 of the wheel well 40. More specifically, the offset flanges 70, 72 and 74 are shaped and oriented to attach to the contoured surface of the mid-area 44 of the wheel well 40 via, for example any of a variety of welding techniques. Further, the offset flange 70 extends in a forward direction D_{F} from the upright flange 76. The offset flange 72 extends downward from the upright flange 76. The offset flange 74 extends in a rearward direction from the upright flange 76. The upright flange 76 of the second bracket 52 is generally vertically oriented and is perpendicular to the upright flange 64 of the first bracket 50.

The upright flange 76 further extends in the vehicle lengthwise direction D_{V} relative to the offset flanges 62. The upright flange 76 includes a third fastener attachment structure 80 and a slot 82 above the third fastener attachment structure 80.

The first bracket 50 and the second bracket 52 are dimensioned, shaped and positioned to receive and support a shelf 90.

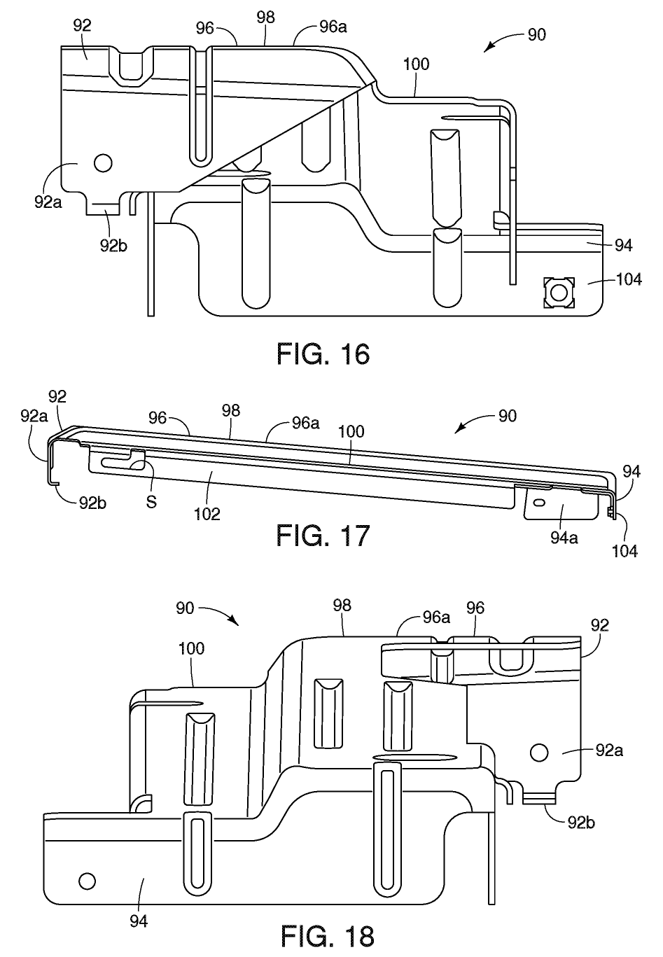

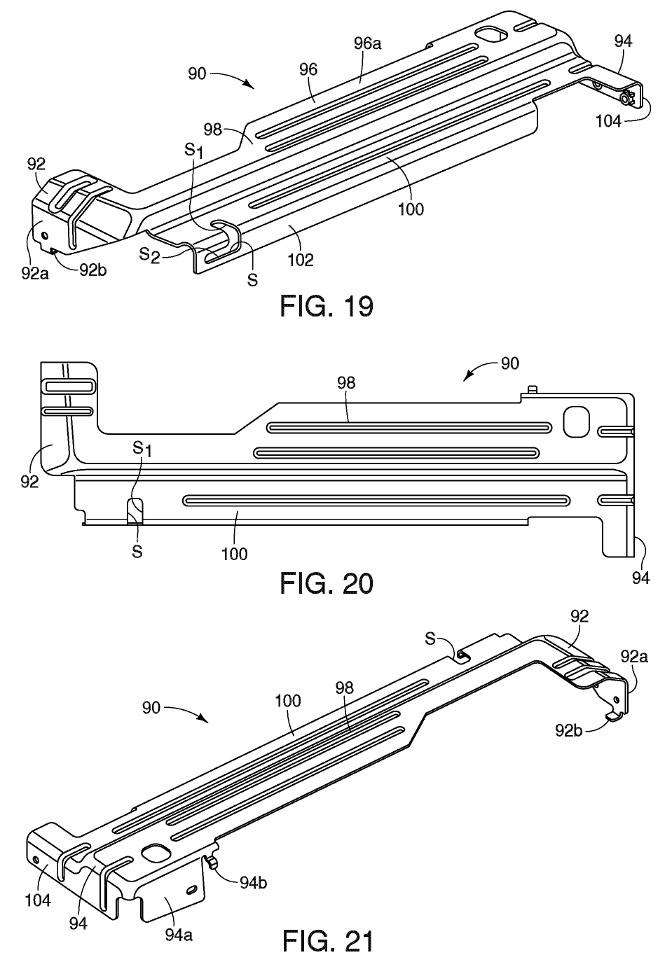

A description of the shelf 90 is now provided with specific reference to FIGS. 16-21. The shelf 90 shelf includes a first end 92 (also referred to as the forward end 92), a second end 94 (also referred to as the rearward end 94) and a main portion 96. The main portion 96 defines an upper surface 96a. The upper surface 96a has a first section 98 and a second section 100. The first section 98 is vertically offset from the second section 100. More specifically, the first section 98 (also referred to as the outboard section 98) is higher than the second section 100 (also referred to as the inboard section 100). The upper surface 96a (including the first and second sections 98 and 100) extend from the forward end 92 to the rearward end 94. The second section 100 also includes a downwardly extending portion 102. A forward area of the downwardly extending portion 102 defines a slot S, described further below. The first section 98 of the upper surface 96a of the shelf 90 is also referred to as an inboard section 98 and the second section 100 of the upper surface 96a of the shelf 90 is also referred to as an outboard section 100. The downwardly extending portion 102 has a generally vertical surface that extends downward from an inboard edge of the second surface section 100. The rearward end 94 of the shelf 90 also includes a downwardly extending flange 104.

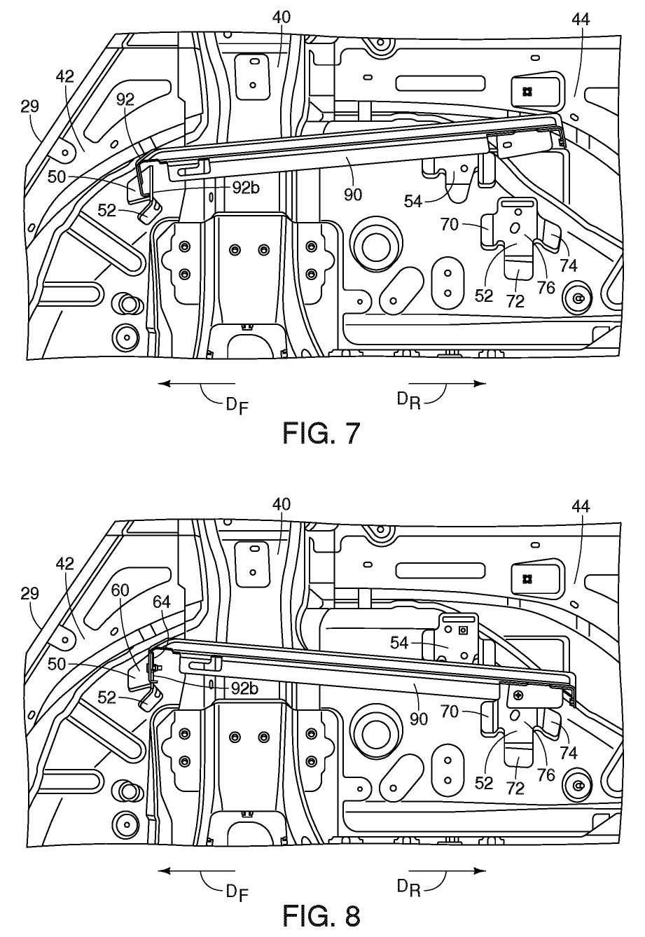

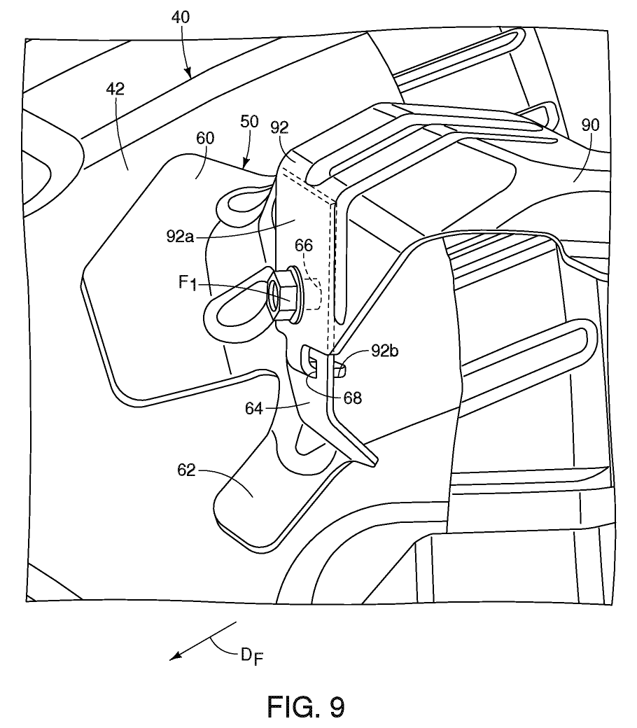

The first end 92 (aka the forward end 92) of the shelf 90 has a downwardly extending flange 92a. A bottom end of the flange 92a includes a protrusion 92b. The first end 92, the flange 92a and the protrusion 92b define a hook shape as shown in FIGS. 17 and 21. As shown in FIGS. 7, 8 and 9, when the shelf 90 is installed to the first bracket 50, the protrusion 92b is inserted into the slot 68 of the first bracket 50. As shown in FIG. 9, thereafter, a fastener F₁ is inserted into an opening in the downwardly extending flange 92a and then threaded into a threaded opening or nut that is defined by the first fastener attachment structure 66 of the upright flange 64 of the first bracket 50, thereby fixedly attaching the forward end 92 of the shelf 50 to the first bracket 50.

Hence, the shelf 90 is shaped and dimensioned such that during installation of the shelf 90 to the first and second brackets 50 and 52, the protrusion 92b of the forward end 92 of the shelf 90 fits into the slot 68 of the first bracket 50 from a forward side of the first bracket 50 thereby hooking to the first bracket 50 limiting rearward movement of the shelf relative to the first bracket 50.

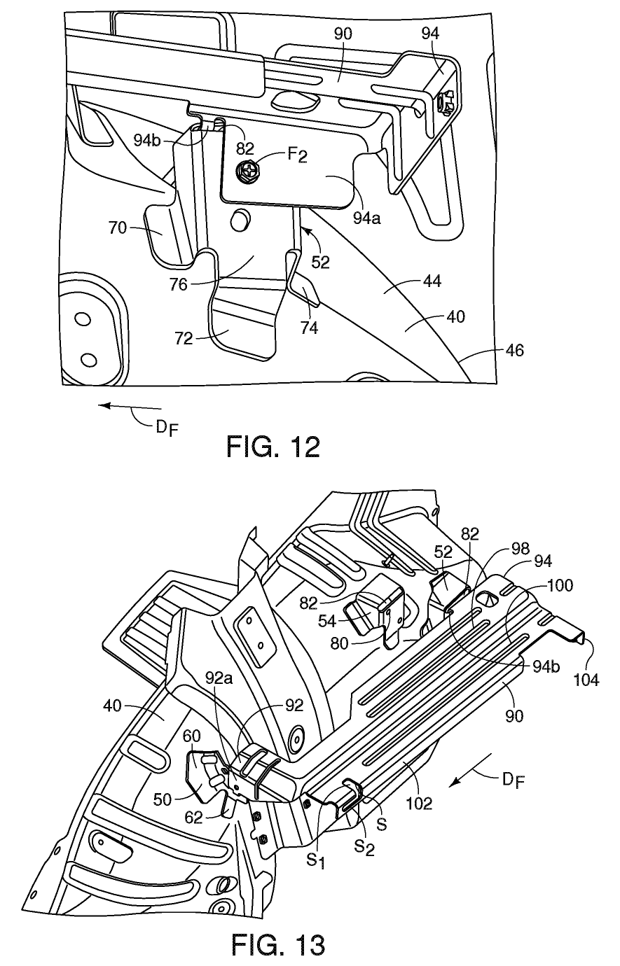

The second end 94 (the rearward end 94) of the shelf 90 has a downwardly extending flange 94a that extends downward from a rearward edge of the first section 98 of the main portion 96 of the shelf 90. Further, the downwardly extending flange 94 is located at an outboard side of the shelf 90. The downwardly extending flange 94a of the rearward end 94 includes a protrusion 94b that extend horizontally in an outboard direction then curves downward again such that the protrusion 94b extends into the slot 82 of the upright flange 76 of the second bracket 52, as shown in FIGS. 12 and 13. As shown in FIG. 12, a fastener F₂ is then threaded into the fourth fastener attachment structure 80, thereby fixedly attaching the rearward end 94 of the shelf 50 to the first bracket 50.

Hence, the protrusion 94b of the rearward end 94 of the shelf 50 is inserted into the slot 82 of the second bracket 52 from above by pivoting the shelf 50 about the first bracket 50 such that the shelf 50 rests on the first and second brackets 50 and 52. The first fastener attachment structure 66 is aligned with the opening for the fastener F₁ (the second fastener structure) and aligns the third fastener attachment structure 80 in the second bracket 52 with an opening in the downwardly extending flange 94a in order to receive the fastener F₂ (the fourth fastener attachment structure).

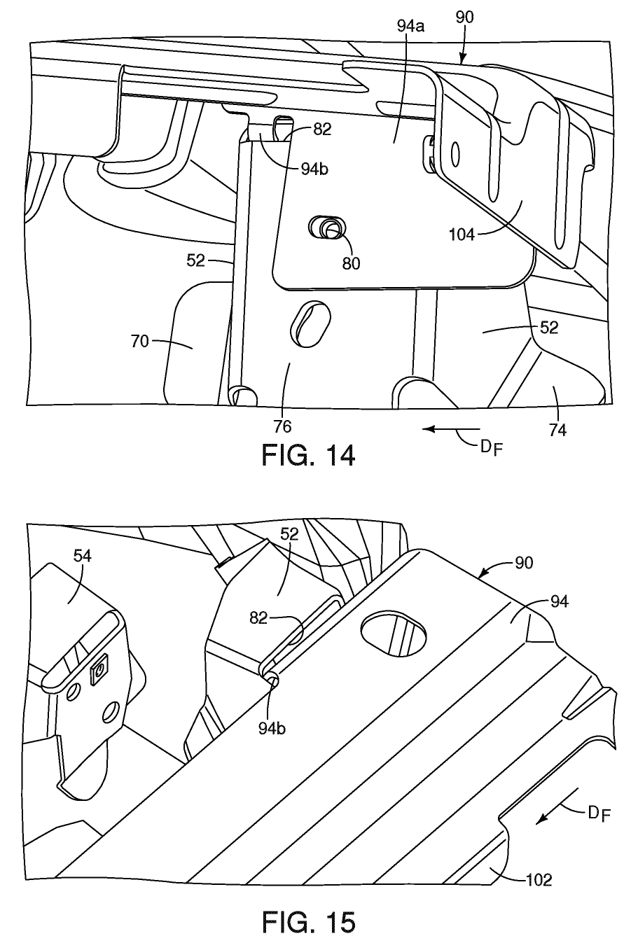

A description of the installation process of the shelf 90 to the first and second brackets 50 and 52 is now provided with specific reference to FIGS. 7-15.

As shown in FIG. 7, the forward end 92 of the shelf 90 is placed on the upright flange 64. Thereafter, the shelf 90 is pulled in the rearward direction D_{R} until the protrusion 92b passes into and part way through the slot 68 of the first bracket 50, as shown in FIG. 9. As shown in FIG. 8, the rearward end 94 of the shelf 90 is pivoted about the first bracket 50 downward until the rearward end 94 is level with the second bracket 52, as shown in FIGS. 8, 12 and 13. During the downward pivoting motion of the rearward end 94, the protrusion 94b is inserted into the slot 82 of the second bracket 52.

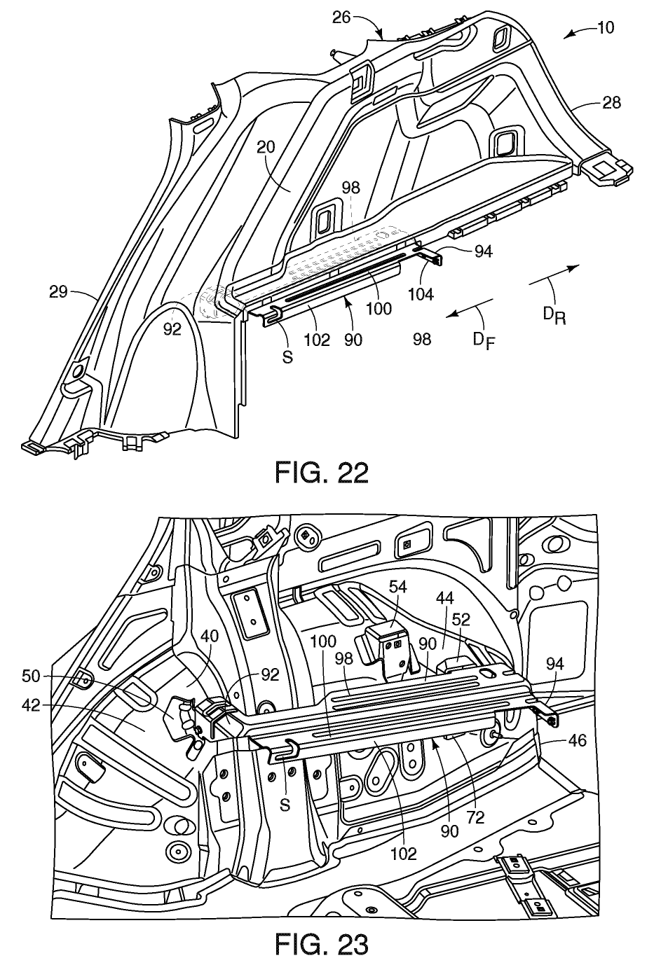

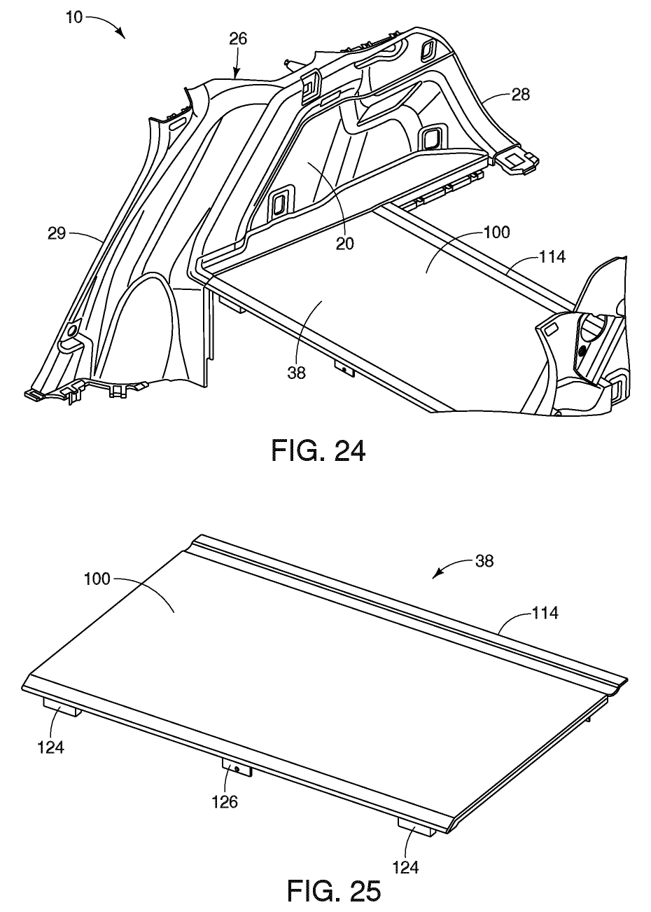

The engagement between the protrusion 94b and the slot 82, combined with the forward end 92 resting on the upright flange 64 of the first bracket 54, maintains the shelf 90 in place until a technician can install the Fastener F₁ to the forward end 92 and upright member 64 and install the fastener F₂ to the rearward end 92 and the upright flange 76 of the second bracket 52, as shown in FIGS. 9 and 12, respectively. Hence, the first end 92 of the shelf 90 is attached to the first bracket 50 and the second end 94 attached to the second bracket 52. Thereafter, the interior trim panel 20 can be installed covering the first and second brackets 50 and 52 and covering outboard portions of the shelf 90, as shown in FIG. 22. A comparison of FIG. 22 (with interior trim panel 20 installed) and FIG. 23 (prior to interior trim panel being installed) shows the various features covered by the interior trim panel 20, including the outboard side 98 of the shelf 90. FIG. 24 shows the lugboard 38 overlaying the inboard side 100 of the shelf 90. The inboard side 100 of the shelf 90 is dimensioned and shaped to support the lugboard 38.

FIG. 30 shows a cargo hook C that is attached to the third bracket 54 (the third bracket 54 is concealed by the interior trim panel 20).

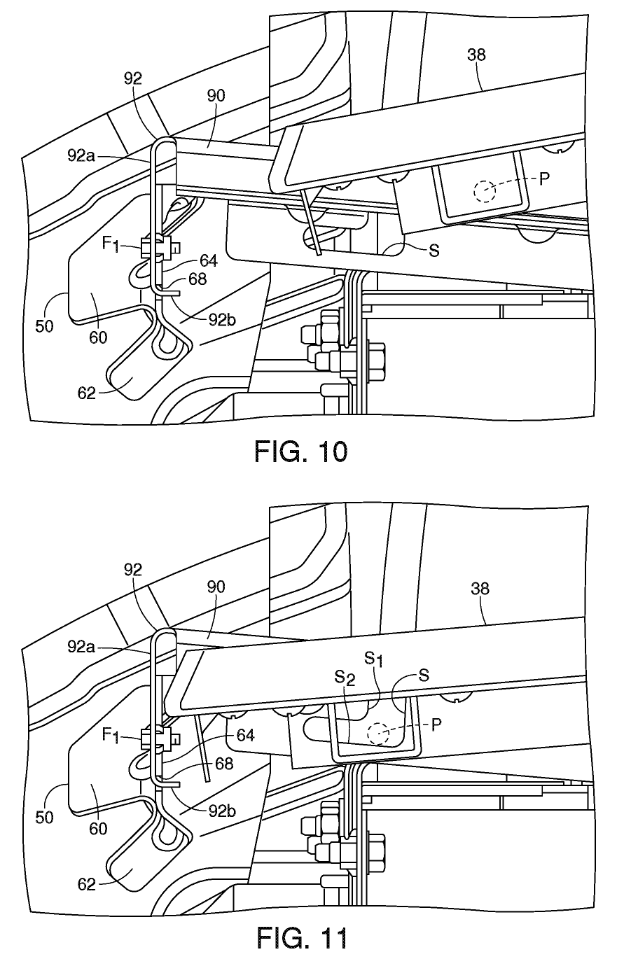

As shown in FIGS. 10-11 and 24, the lugboard 38 can be installed to the second section 100 of the shelf 90, as described in greater detail below.

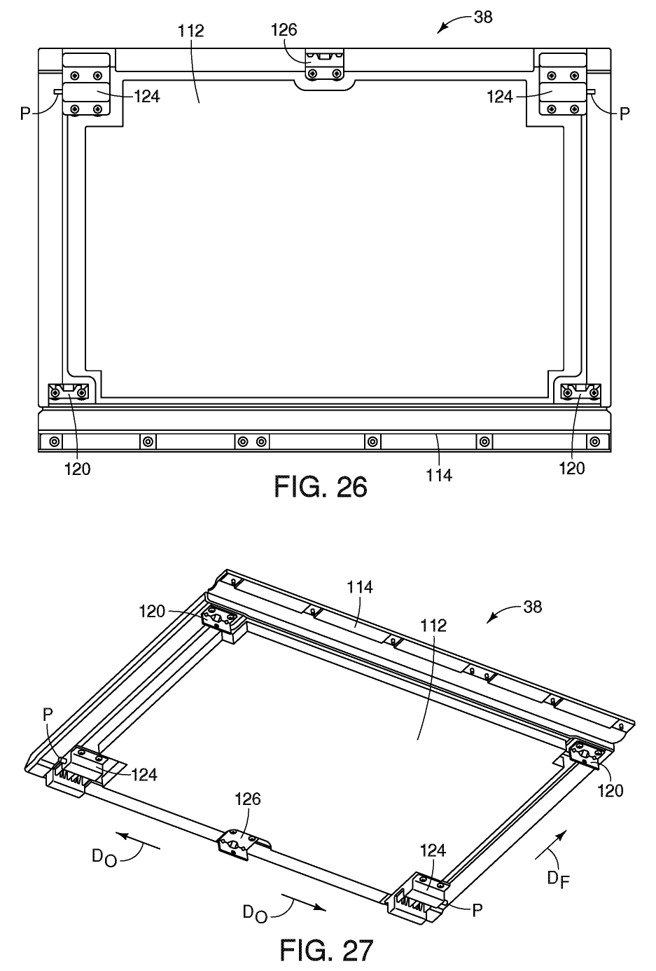

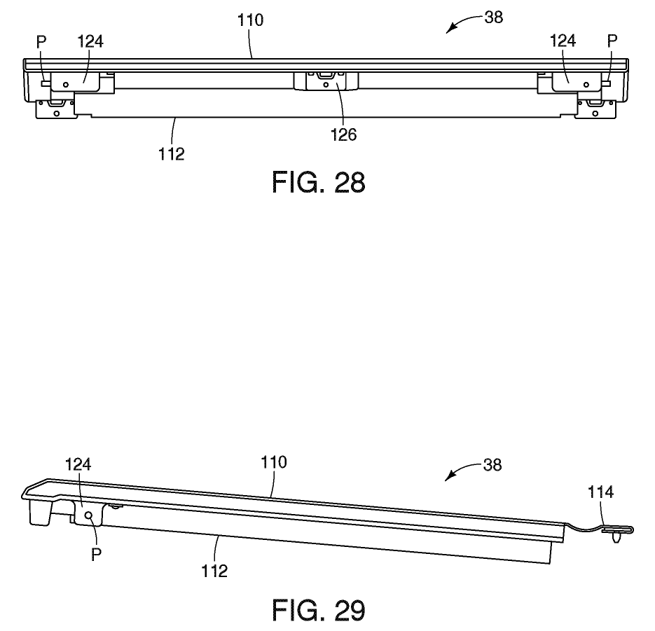

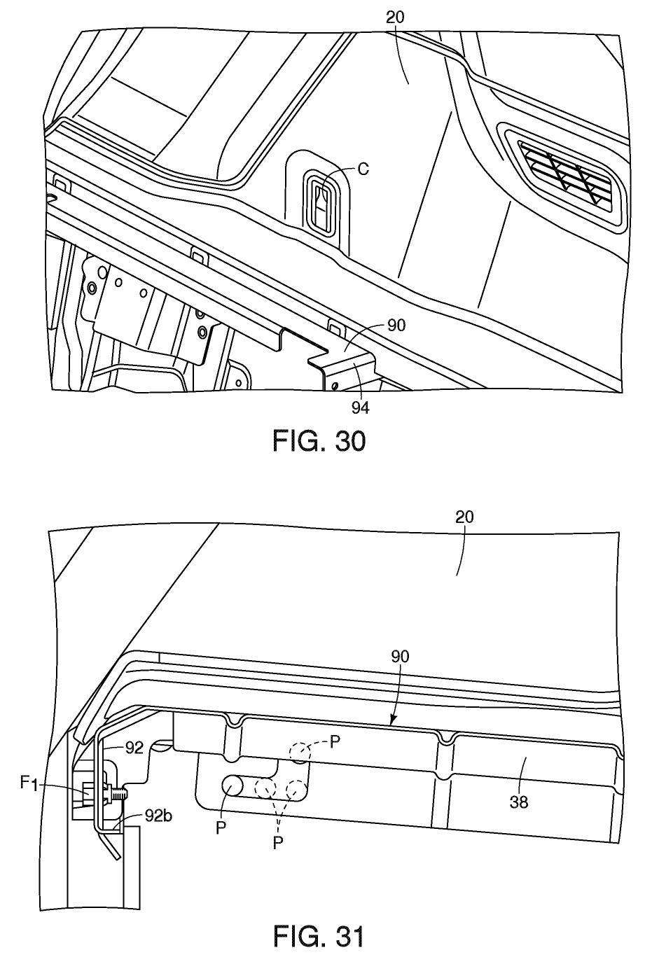

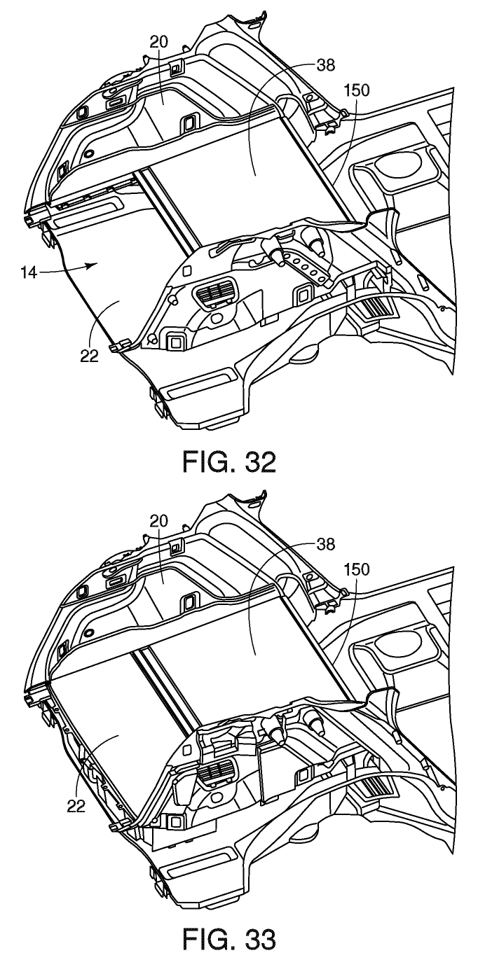

A description of the lugboard 38 is now provided with specific reference to FIGS. 25-27. The shelf 90 has a slot S located adjacent to the forward end 92 of the shelf 90. The slot S as a first section S₁ and a second section S₂. The first section S₁ is defined by the second section 100 (the inboard surface section 100) of the shelf 50 and is open to the upper surface 96a of the shelf 50. The second section S₂ is open to and extends along the vertical surface of the downwardly extending portion 102 of the shelf 50.

The lugboard 38 is basically a rigid board that has an upper surface 110 and a lower surface 112. The upper surface 110 is defined by carpet material that covers the rigid board and extends from a rearward end of the lugboard 38 defining a hinged gap cover 114. The lower surface 112 includes brackets 120,124 and 126. There are two brackets 120 that are fixed to rearward corners of the lower surface 112 adjacent to opposite ends of the hinged gap cover 114. There are also two brackets 124 fixed to forward corners of the lower surface 112. Each of the brackets 124 includes a pin P that extends in an outboard direction D_{O}.

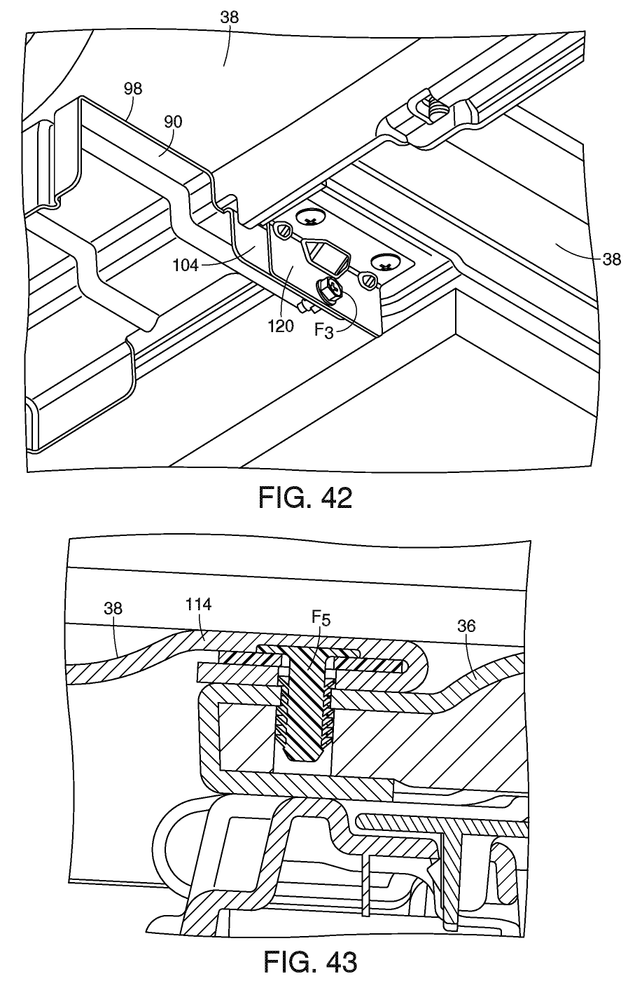

There are two pins P, one on each side of the lugboard 38. Similarly, as discussed above, there are two shelves 90, one on each side of the cargo area 14. When the lugboard 38 is installed in the cargo area 14 to cover and conceal the concealed compartment 34, the pins P are moved forward until the pins P align and pass into the first section S₁ and then dropped into the second section S₂, as shown in FIGS. 10, 11, 31 and 35-36. Once the pin P is in the lower part of the slot S (the second section S₂) the lugboard 38 and the pin P are moved in the forward direction D_{V} until the Pin P is in a forwardmost location within the second section S₂ of the slot S. Thereafter, the brackets 120 of the lugboard 38 are secured to the downwardly extending flange 104 of the shelf 90 by fasteners F₃, as shown in FIG. 42.

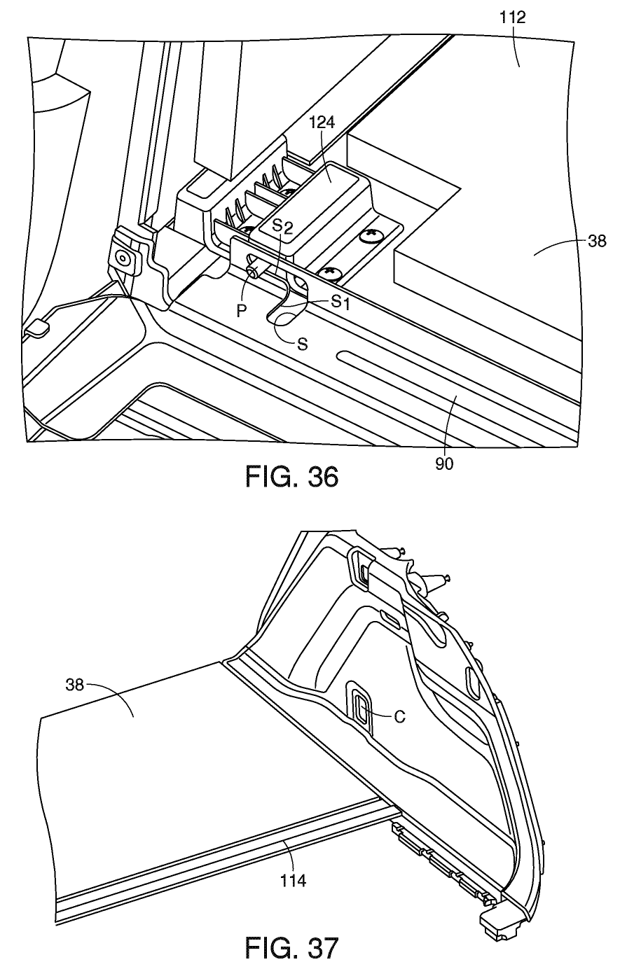

Hence, the pin P of the lugboard 38 extends from beneath a portion of the lugboard 38, and is oriented and dimensioned to pass into the first section S₁ of the slot S during positioning of the lugboard 38 on the shelf 90. The pin P is further oriented and dimensioned such that with an edge portion of the lugboard 38 overlaying the upper surface 100 of the shelf 38, movement of the lugboard 38 in a forward direction correspondingly moves the pin P along the second section S2 of the slot S away from the first section S₁ of the slot S. As shown in FIGS. 35 and 36, the slot S has an overall L-shape as viewed from one side thereof.

Further, the lugboard 38 includes the brackets 120 attached to a forward area of a lower surface 112 of the bracket 38. The bracket 120 define a fastener receiving opening that aligns with an opening in the downwardly extending flange 104 of the shelf 90. Once aligned, the mechanical fastener F₃ is installed through the fastener receiving opening and through the opening in the downwardly extending flange of the shelf secures the lugboard to the shelf 38.

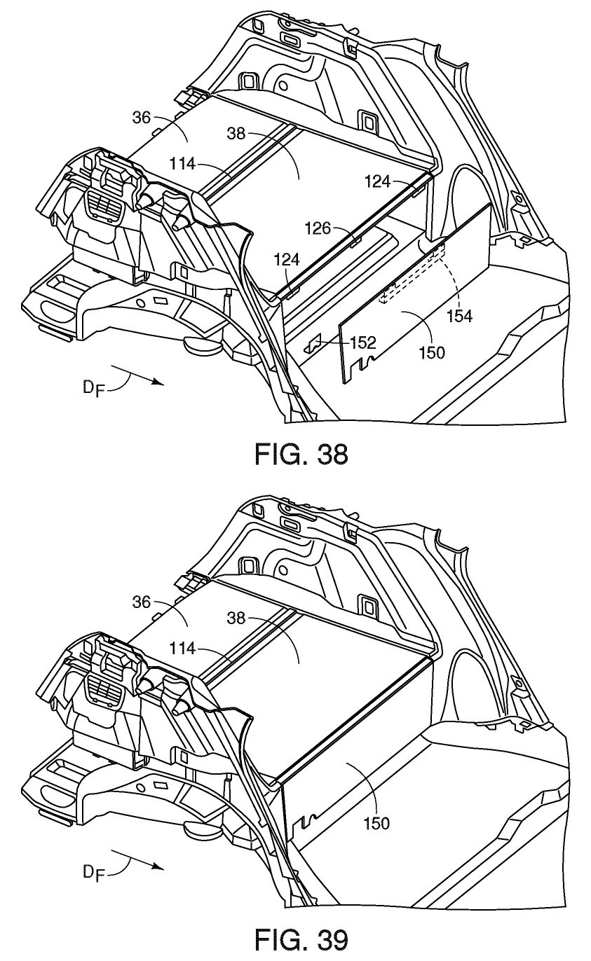

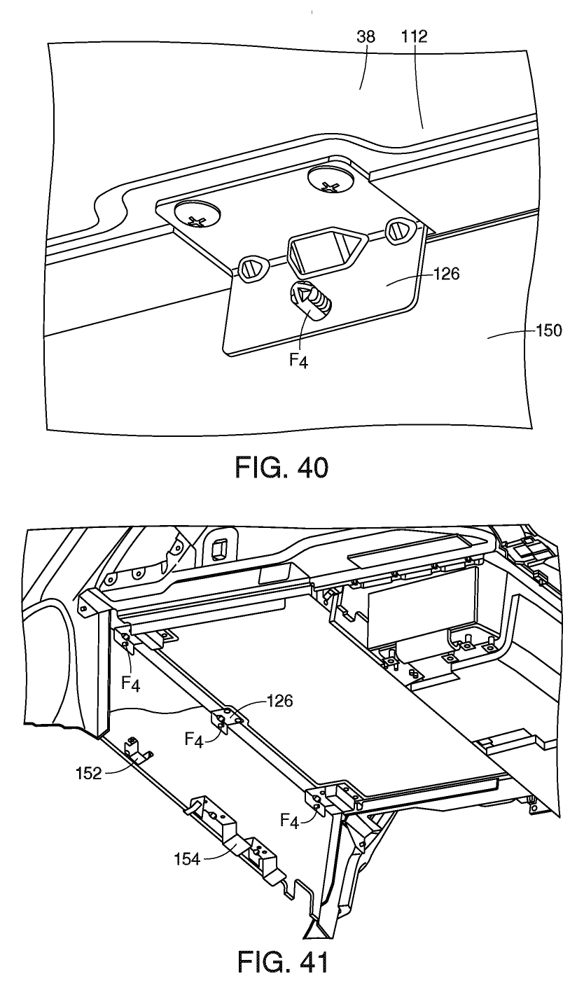

As shown in FIGS. 38 and 39, a forward upright panel 150 encloses the front of the concealed compartment 34. The forward upright panel 150 (also referred to as an upright closer panel 150) fits to the front of the concealed compartment 34 and is attached at an upper end to the brackets 120 and 124 via fasteners F4, as shown in FIG. 40 and 41. The forward upright panel 150 is also attached via mechanical fasteners to the floor brackets 152 and 154.

A gap is defined between the lug box 30 and the concealed compartment 34. The hinged gap cover 114 covers this gap, as shown in FIGS. 39 and 47. The hinged gap cover 114 is part of the lugboard 38 and is preferably made of durable carpet material that can also function as a living hinge. The durable carpet material covers the entire upper surface 110 of the lugboard 38 and defines the hinged gap cover 114.

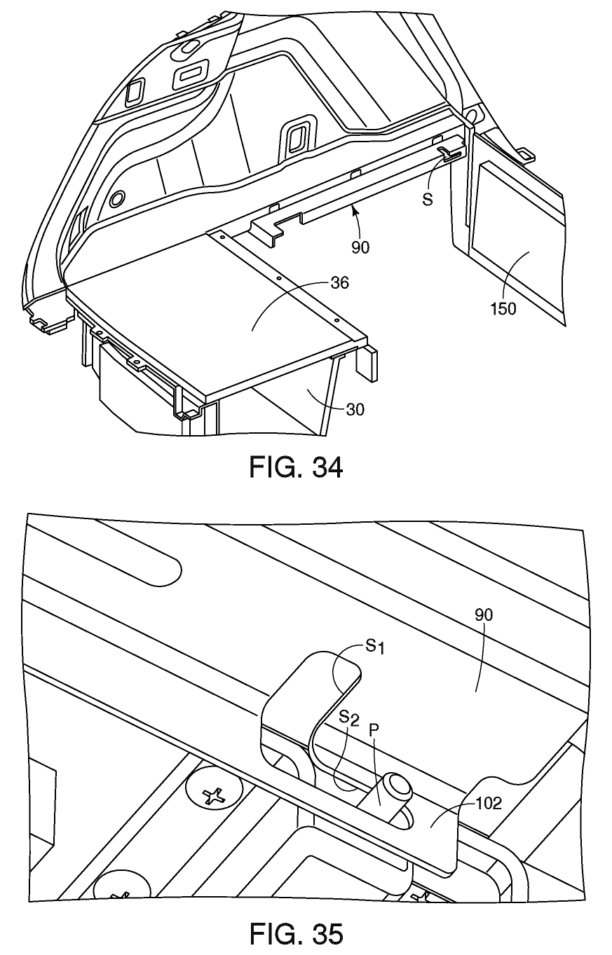

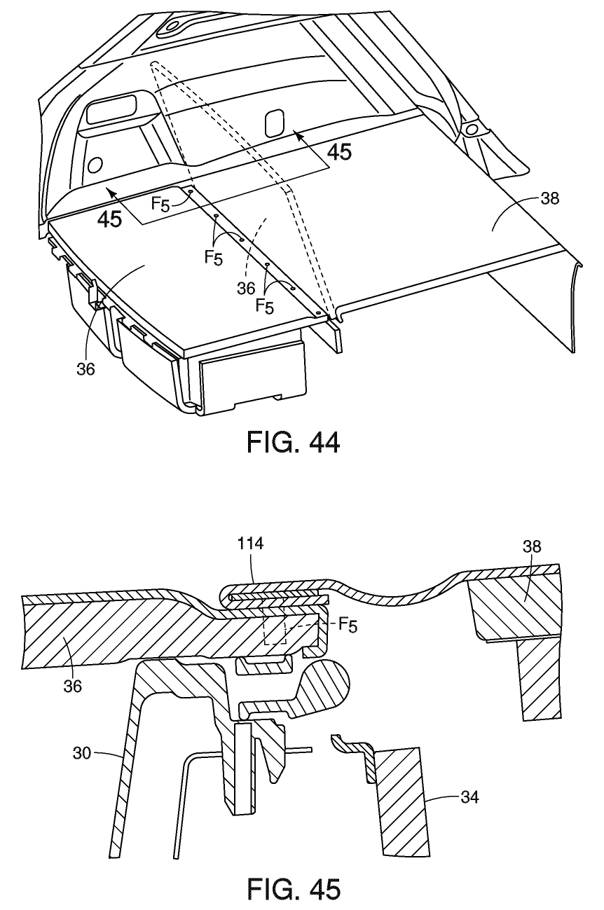

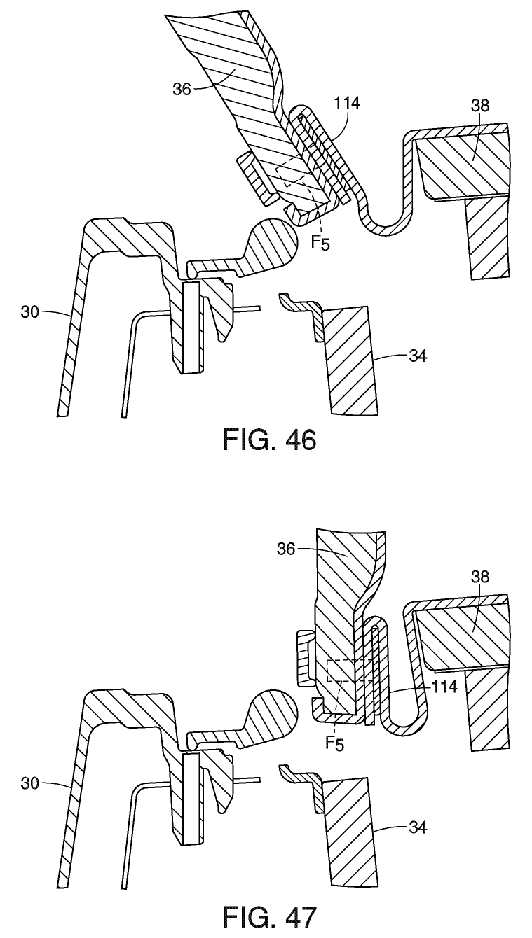

As shown in FIGS. 3-4 and 44-47, the lug box lid 36 can pivot about the gap between a closed orientation covering the lug box 30 (FIGS. 4, 33, 44 (solid lines) and 45) and an open orientation exposing the interior of the lug box 30 (FIGS. 3, 44 (in phantom lines) and 47). The hinged gap cover 114 (also referred to as a gap filler) can serve as a hinge for the lug box lid 36. The hinged gap cover 114 is attached to the lug box lid 36 via fasteners F₅.

The various vehicle body structure elements and panels not described above are conventional components that are well known in the art. Since they are well known in the art, these structures will not be discussed or illustrated in detail herein. Rather, it will be apparent to those skilled in the art from this disclosure that the components can be any type of structure and/or programming that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, "including", "having" and their derivatives. Also, the terms “part,” “section,” “portion,” “member” or “element” when used in the singular can have the dual meaning of a single part or a plurality of parts. Also as used herein to describe the above embodiment, the following directional terms “forward”, “rearward”, “above”, “downward”, “vertical”, “horizontal”, “below” and “transverse” as well as any other similar directional terms refer to those directions of a vehicle equipped with the vehicle rear cargo structure. Accordingly, these terms, as utilized to describe the present invention should be interpreted relative to a vehicle equipped with the vehicle rear cargo structure.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle rear cargo structure, comprising:
a side wall;
a shelf coupled to the side wall, the shelf having an upper surface and a vertical surface that extends downward from the upper horizontal surface, a slot having a first section and a second section, the first section being open to the upper surface of the shelf and the second section of the slot being open to and extending along the vertical surface of the shelf; and
a lugboard having a pin extending from beneath a portion of the lugboard, the pin being oriented and dimensioned to pass into the first section of the slot during positioning of the lugboard on the shelf, the pin being further oriented and dimensioned such that with the portion of the lugboard overlaying the upper surface of the shelf, movement of the lugboard correspondingly moves the pin along the second section of the slot away from the first section of the slot.

2. The vehicle rear cargo structure according to claim 1, wherein
the pin extends in a direction parallel to an upper surface of the lugboard.

3. The vehicle rear cargo structure according to claim 2, wherein
the second section of the slot extends in a direction parallel to the upper surface of the shelf.

4. The vehicle rear cargo structure according to claim 1, wherein
the second section of the slot extends in a direction parallel to the upper surface of the shelf.

5. The vehicle rear cargo structure according to claim 1, wherein
the slot has an overall L-shape as viewed from one side thereof.

6. The vehicle rear cargo structure according to claim 1, wherein
the shelf includes a rearward end and a forward end with the upper surface extending therebetween, the slot is located adjacent to the rearward end and a downwardly extending flange is located at the forward end of the shelf.

7. The vehicle rear cargo structure according to claim 6, wherein
the lugboard includes a bracket attached to a forward area of a lower surface of the bracket, the bracket defining a fastener receiving opening that aligns with an opening in the downwardly extending flange of the shelf with the portion of the lugboard overlaying the upper surface of the shelf and the lugboard being moved such that the pin has been slid along the second section of the slot away from the first section of the slot, a mechanical fastener installed through the fastener receiving opening and through the opening in the downwardly extending flange of the shelf secures the lugboard to the shelf.

8. The vehicle rear cargo structure according to claim 1, further comprising
a lug box lid located rearward of the lugboard such that a gap is defined between the lug box lid and the lugboard, and
a forward end of the lugboard has a gap filler that includes a first part and a second part, the first part connected to the lugboard via a first hinge and the second part connected to the first part via a second hinge, the second part being attached to the lug box lid such that movement of a lug box lid from a horizontal orientation to an upright orientation causes the first part to pivot about the first hinge in a downward direction into the gap and the second part pivots about the second hinge folding the second part against the first part about the second hinge.

9. The vehicle rear cargo structure according to claim 8, wherein
the gap filler includes a carpet surface and the first hinge and second hinge are both living hinges.

10. The vehicle rear cargo structure according to claim 1, further comprising
a storage space defined adjacent to a bottom section of the side wall, the storage space defining a forward area and a rearward area, the lugboard covering the forward area;
a lug box located within the rearward area of the storage space; and
a lug box lid attached to the side wall for pivoting movement between a closed orientation covering the lug box and an open orientation exposing the lug box, the lug box lid being rearward of the lugboard such that a gap is defined between the lug box and the lugboard.

11. The vehicle rear cargo structure according to claim 10, wherein
a forward end of the lugboard has a gap filler that includes a first part and a second part, the first part connected to the lugboard via a first hinge and the second part connected to the first part via a second hinge, the second part being attached to the lug box lid such that movement of a lug box lid from the closed orientation to the open orientation causes the first part to pivot about the first hinge in a downward direction into the gap and the second part pivots about the second hinge folding the second part against the first part about the second hinge.

12. The vehicle rear cargo structure according to claim 11, wherein
the gap filler is at least partially a carpet material and the first hinge and second hinge are both living hinges.

13. The vehicle rear cargo structure according to claim 1, further comprising
an upright closer panel attached to a forward end of the lugboard.

14. The vehicle rear cargo structure according to claim 13, wherein
the lugboard includes at least one securing bracket located along a forward edge thereof having a fastener opening defined therein, the upright closer panel having mechanical fastener extending from an upper area of a rearward facing surface such that the mechanical fastener extends through the fastener opening attaching the upright closer panel to the lugboard.

15. The vehicle rear cargo structure according to claim 14, wherein
the lugboard includes a reinforcing block fixed to a bottom surface of the lugboard at a rearward corner thereof, the pin being fixed to the reinforcing block and extending therefrom.

16. The vehicle rear cargo structure according to claim 15, wherein
the reinforcing block further includes another fastener receiving opening and the upright closer panel having another mechanical fastener extending from an upper corner thereof, the another mechanical fastener extending into the another fastener receiving opening further attaching the upright closer panel to the lugboard.

17. The vehicle rear cargo structure according to claim 13, further comprising
a floor that extends inboard from a lower end of the sidewall, the floor having at least one floor bracket fixedly attached to an upper surface of the floor, and
a lower end of the upright closer panel is attached to the at least one floor bracket via a mechanical fastener.

18. The vehicle rear cargo structure according to claim 1, wherein
the lugboard includes a reinforcing block fixed to a bottom surface of the lugboard at a rearward corner thereof, the pin being fixed to the reinforcing block and extending therefrom.

19. The vehicle rear cargo structure according to claim 1, wherein
the upper surface of the shelf has a first surface section and a second surface section, the first surface section being vertically higher than the second surface section, and
the lugboard rests on the second surface section.

20. The vehicle rear cargo structure according to claim 19, wherein
the vertical surface of the shelf extends downward from an inboard edge of the second surface section.
